(19) United States
(12) Patent Application Publication
(10) Pub. No.: US 2025/0242260 A1
(43) Pub. Date: Jul. 31, 2025

(54) SYSTEM AND METHOD FOR MONITORING AND OPTIMIZING PLAYER ENGAGEMENT

(71) Applicant: Begin AI Inc., Halifax (CA)

(72) Inventor: Rima AL SHIKH, Halifax (CA)

(21) Appl. No.: 18/426,965

(22) Filed: Jan. 30, 2024

(51) Int. Cl. A63F 13/65

(52) U.S. Cl. CPC A63F 13/65

(57) ABSTRACT

Described are various embodiments of system and method for monitoring and optimizing player engagement. In some embodiments, the computer-implemented method comprises generating, on a server, a storage layer in the form of a graph drawn according to a schema description of objects and relationships in a virtual game environment. The server produces, from the received schema and learning system objectives, one or more instructions. The instructions are transmitted to and applied by a gaming device configured to execute a designated interactive software program, to produce from raw data generated one or more embeddings. The embeddings are stored in the graph, and retrieved to perform one or more data analysis tasks on the designated embeddings by one or more machine learning algorithms. The embeddings can be augmented or optimized into contextualized preferences embeddings or contextualized timeline embeddings, to allow better contextual learning and predictive outputs.

### FIELD OF THE DISCLOSURE

The present disclosure relates to distributed machine learning, and, in particular, to a system and method for monitoring and optimizing player engagement.

### BACKGROUND

Video game companies rely on various means to keep the players engaged. This is important for (revenue, etc.). However, data science teams are often capped over capacity and are looking for ways to reduce their workload. In addition, the amount of data generated by each user is difficult and expensive to process on servers in real-time.

Existing solutions are often too complex: capturing, processing and preparing data is heavy on planning and engineering. Running machine learning (ML) and artificial intelligence (AI) models can be very expensive. Moreover, increasing data resolution (e.g., tracking more and more data) requires additional engineering cycles.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for a system and method for monitoring and optimizing player engagement that provides a distributed machine learning infrastructure.

A computer-implemented method, comprising the steps of: generating, on a server, a storage layer in the form a graph drawn according to a schema description of objects and relationships in a virtual game environment; producing, at the server, from the received schema and one or more one or more learning system objectives, one or more instructions; transmitting, via a network, from the server to a gaming device configured to execute an interactive software, the one or more instructions; applying, by the gaming device, the one or more instructions on raw data generated by the interactive software to create the one or more embeddings; returning, from the gaming device to the server, the one or more embeddings; storing, at the server, the one or more embeddings in the graph; retrieving, at the server, by a machine learning algorithm, one or more designated embeddings from the graph; performing, at the server, one or more data inference tasks on the designated embeddings by one or more machine learning algorithms to produce one or more predictive outputs; and adjusting, at the gaming device, one or more parameters of the interactive software in accordance with the one or more predictive outputs.

In some embodiments, the computer-implemented method further comprises the steps of, before said generating, receiving, at a user device, from a user, via a user interface of said second device, the schema description and the one or more learning objectives; and transmitting, from the second user device to the server, the schema and the one or more learning objectives.

In some embodiments, the nodes of the graph represent game-related real-word or virtual entities, and the edges represent relationships between the entities.

In some embodiments, the game-related real-world or virtual entities include a person using the interactive software.

In some embodiments, the computer-implemented method further comprises the step of, before said performing: training the one or more machine learning algorithms on the one or more embeddings.

In some embodiments, the designated embeddings include contextualized embeddings.

In some embodiments, the contextualized embeddings are generated by: fetching, by the server, raw embeddings received from the gaming device from the graph; optimizing, by the server, the raw embeddings into contextualized embeddings; and returning, by the server, the contextualized embeddings to the graph for storage.

In some embodiments, the contextualized embeddings include contextual information selected from the list of: an item; an interaction; a user and similar users; and similar user behavior.

In some embodiments, the contextualized embeddings include timeline embeddings, the timeline embeddings comprising time-related parameter change information.

In accordance with another aspect, there is provided a system comprising: a server, the server configured to: generate a storage layer in the form a graph drawn according to a schema description of objects and relationships in a virtual game environment; and produce from the schema description and one or more learning system objectives, one or more instructions; a gaming device configured to execute a designated interactive software and communicatively coupled to the server via a network, the gaming device configured to: receive the one or more instructions from the server; apply the one or more instructions on raw data generated by the interactive software to create the one or more embeddings; return to the server the one or more embeddings; and wherein the server is further configured to: store the one or more embeddings in the graph; retrieve via a machine learning algorithm, one or more designated embeddings from the graph; perform one or more data inference tasks on the designated embeddings via the machine learning algorithm to produce one or more predictive outputs; and wherein the gaming device is further configured to adjust one or more parameters of the interactive software in accordance with the one or more predictive outputs.

In some embodiments, the system further comprises a user device communicatively coupled to the server, and operate to generate a user interface via a display of the user device; wherein the user device is further configured to receive, via the user interface, the schema description and one or more learning objectives; transmit the schema and the one or more learning objectives to the server.

In some embodiments, the nodes of the graph represent game-related real-word or virtual entities, and the edges represent relationships between the entities.

In some embodiments, the game-related real-word or virtual entities include a person using the interactive software.

In some embodiments, the server is further configured to, before performing the one or more data analysis tasks, to train the one or more machine learning algorithms on the one or more embeddings.

In some embodiments, the designated embeddings include contextualized embeddings.

In some embodiments, the server generates the contextualized embeddings by: fetching raw embeddings received from the gaming device from the graph; optimizing the raw embeddings into contextualized embeddings; and returning the contextualized embeddings to the graph for storage.

In some embodiments, the contextualized embeddings include contextual information selected from the list of: an item; an interaction; a user and similar users; and similar user behavior.

In some embodiments, the contextualized embeddings include timeline embeddings, the timeline embeddings comprising time-related parameter change information.

Other aspects, features and/or advantages will become more apparent upon reading of the following non-restrictive description of specific embodiments thereof, given by way of example only with reference to the accompanying drawings.

### BRIEF DESCRIPTION OF THE DRAWINGS

Several embodiments of the present disclosure will be provided, by way of examples only, with reference to the appended drawings, wherein:

FIG. 1 is a schematic diagram of a system for monitoring and optimizing user engagement, in accordance with one embodiment;

FIG. 2 is another schematic diagram of a system for monitoring and optimizing user engagement, in accordance with another embodiment;

FIG. 3 is a schematic diagram illustrating features provided by the systems of FIG. 1 and FIG. 2, in accordance with one embodiment;

FIG. 4 is an example of user interface for creating and amending schemas, in accordance with one embodiment;

FIG. 5A and FIG. 5B are schematic diagrams illustrating different examples of a graphical data layer for storing embeddings, in accordance with one embodiment;

FIG. 6A and FIG. 6B are schematic diagrams of an exemplary graph and its embeddings, respectively, in accordance with one embodiment;

FIG. 7 is a flow diagram of a player engagement tracking and optimization method, in accordance with one embodiment;

FIG. 8A and FIG. 8B are schematic diagrams illustrating designated method steps of FIG. 7, in accordance with one embodiment.

FIG. 9A and FIG. 9B are schematic diagrams illustrating contextualization of embeddings, in accordance with one embodiment.

FIG. 10 is a schematic diagram illustrating a recommendation provided by the system of FIG. 1 or FIG. 2, in accordance with one embodiment;

FIG. 11 is a photograph of a user interface for creating a schema, in accordance with one embodiment;

FIG. 12A, FIG. 12B and FIG. 12C are photographs of an exemplary user interface used for adding objects to a schema, in accordance with one embodiment;

FIG. 13A, and FIG. 13B are photographs of an exemplary user interface used for adding attributes to an object to the schema, in accordance with one embodiment;

FIG. 14A and FIG. 14B are photographs of an exemplary user interface for adding labels to an object of the schema, in accordance with one embodiment;

FIG. 15A and FIG. 15B are photographs of an exemplary user interface for adding interactions to the schema, in accordance with one embodiment;

FIG. 16A and FIG. 16B are photographs of an exemplary user interface for adding attributes to interactions, in accordance with one embodiment;

FIG. 17A and FIG. 17B are photographs of an exemplary user interface for uploading JSON schema definitions, in accordance with one embodiment;

FIG. 18 is a photograph of an exemplary user interface for generating integration code, in accordance with one embodiment;

FIG. 19A, FIG. 19B and FIG. 19C are photographs of an exemplary user interface for displaying various session metrics and analytics, in accordance with one embodiment;

FIG. 20 is a photograph of an exemplary user interface for displaying training metrics, in accordance with one embodiment;

FIG. 21 is a photograph of an exemplary user interface for displaying machine learning model performance, in accordance with one embodiment;

FIG. 22A, FIG. 22B and FIG. 22C are photographs of an exemplary user interface for displaying player engagement analytics, in accordance with one embodiment; and

FIG. 23 is a flow diagram illustrating a method for monitoring engagement trends and detecting player changes in patterns and interventions, in accordance with one embodiment.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

The present disclosure, in accordance with different embodiments, includes a system and method for monitoring and optimizing player engagement in a video game. This includes performing distributed machine learning for electronic entertainment or game software engagement optimization. In some embodiments, the system and method provides a decentralized or distributed computing mechanism to generate processable data from local raw user/player data on distributed networked gaming or computing devices where the raw data is stored. The processable data may have the form of a useful representation of the raw player data, and can be used by a machine learning (ML) algorithm or the like trained on a remote server. By locally processing the raw player data on the edge (e.g., on each networked gaming device), and sending the processable data to the remote server, the storing and processing requirements on the server or the cloud infrastructure is greatly reduced. This allows the system to easily scale the number of devices used by the system. In addition, decentralized learning allows to keep the game or player data on the local gaming device, reducing the risk of data or security breaches. In addition, the system of the present disclosure may optimize or augment embeddings by adding contextual or time-related information. These provide improved outputs from the machine learning algorithms, provides better monitoring metrics and allow the system to dynamically adjust game-related parameters to increase player engagement.

In addition, the system and method of the present disclosure further allows to determine personalized interventions required to help a player improve in their game play, for example by comparing players that are declining in their success in the game with players of similar state that are having more success and determining parameters in the game that could be adjusted for the player to allow them better success and to enjoy the game more, ensuring the parameters are optimized to keep player in the flow state and not making the game too hard or too easy. After personalized interventions are served to the player in the form of adjusting game parameters, these interventions are tracked and recorded and where the analytics dashboard can demonstrate the effectiveness of these interventions giving the product managers the ability to add more control parameters in the game for more subtle interventions that maintain the game balance and drive more success in player engagement.

The terms “video game”, “computer game” or “game” in the present disclosure are generally understood to include any interactive entertainment products or software played by one or more players and that involves interaction with a user interface or input device to generate visual feedback from a display device. Typically, games are “played” by players or users via a “gaming” device which is generally a computing device. Examples of “gaming devices” may include, without limitation, desktop computers, laptops, smartphones, tablets, smart watches, gaming consoles, handheld gaming consoles or the like. Displays may include television sets, computer monitors, flat panel displays, touchscreens or virtual reality headsets. In some embodiments, the computing device may include speakers, haptic feedback devices, microphones, cameras or the like. In some embodiments, the gaming device may have the display and/or additional features included in a same physical device. Importantly, the skilled person the art will understand that the present disclosure discusses interfacing with gaming software or games as an example only, and that the system and method described herein could equally be applied to other types of software or electronic entertainment that a user may actively engage with, without restriction.

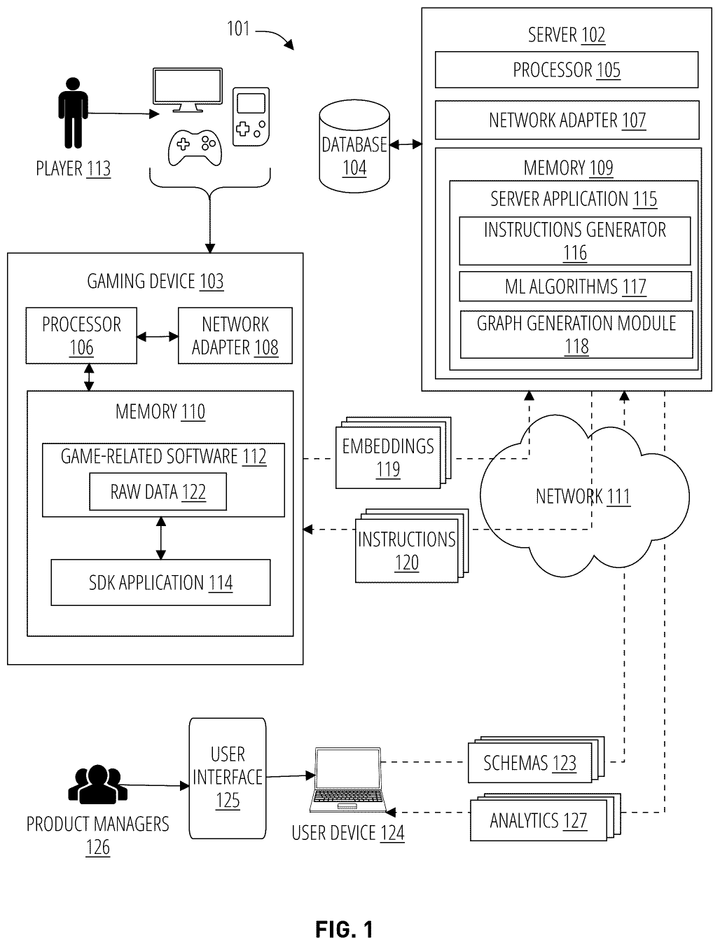

In accordance with one embodiment, FIG. 1 is a schematic diagram of an exemplary system 101 comprising a server 102 and at least one gaming or computing device 103. A single gaming device 103 is illustrated for simplicity of description only, and there is no limit on how many devices may be communicatively coupled to the server 102. Similarly, it will be appreciated that the server 102 may be implemented via one or more servers, and that certain processing tasks may be distributed among those servers. In some embodiments, the server 102 may be communicatively coupled to one or more databases 104.

Each of the server 102 and gaming device 103 comprises a processor 105, 106, a network adapter 107, 108 and a memory 109, 110. The gaming device 103 is communicatively coupled to the server 102 via a network 111. The gaming device 103 typically has stored on its memory game-related software 112 comprising instructions for executing the game locally, or include a software interface to cloud-based games run on servers or the like. In some embodiments, this may include software executed inside a browser application or the like. In both cases, the gaming device 103 is used by a first user or player 113 to interactively engage with the game-related software 112 via one or more input methods.

The system 101 further comprises stored in the memory 110 of the gaming device 103 an SDK application 114 which is configured to interfaces with the game-related software 112. In some embodiments, the SDK application 114 may be in the form of a software library implementing an API that provides a number of functions for generating embeddings and communicating with the game-related software 112 and server 102. The game-related software 112 in turn is typically configured or programmed to use one or more functions of the SDK application 114, including requesting one or more recommendations.

The server 102 has stored on its memory 109 a server application 115. In some embodiments, the server application 115 may include an instruction generator module 116, one or more machine learning algorithms 117, and a graph generation module 118. The instructions generator module 116 is configured to generate a plurality of instructions for generating embeddings 119. The one or more ML algorithms 117 are used for training and/or to perform inference on embeddings 119 generated on the gaming device 103 by applying the instructions 120 on raw game-related data 122. The embeddings 119 are sent back to the server 102 and the graph generation module 118 is used to store the one or more embeddings 119 in the form of graphs drawn in accordance with a schema 123 representing one or more aspects of the game universe.

The server 102 is communicatively couple via the network 111 to at least one user device 124. The user device 124 is configured to provide a User Interface 125 (UI) to a “dashboard” user such as a product manager 126. The product managers 126 may, via the UI 125, provide a schema 123 and additional information (e.g., learning objectives, requests for information/analytics, etc.) to the server application 115. In addition, it provides integration source code that may be integrated by the developers in the game-related software 112 to interface with the SDK application 114. In return, the server 102 provides the UI 125 with analytics 127 for the manager. In some embodiments, the UI 125 may be configured to allow the product manager or user 126 to describe player interactions with the virtual game world.

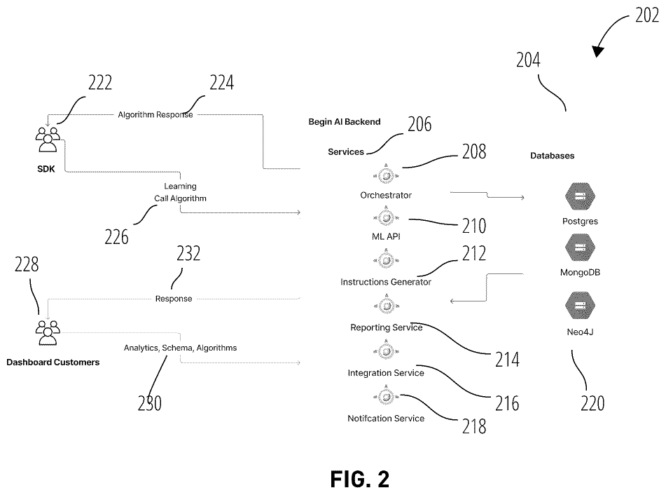

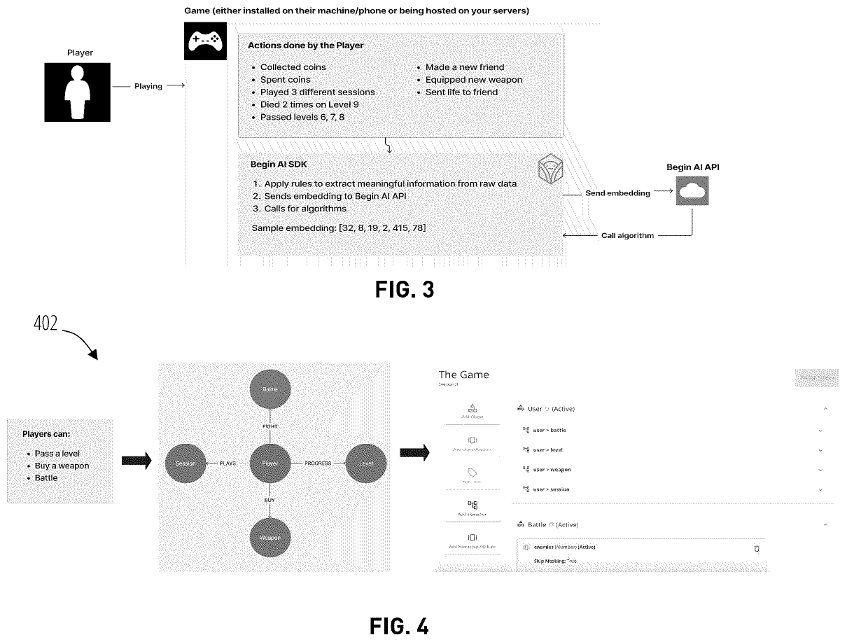

FIG. 2 and FIG. 3 illustrate another implementation of a system 202 in accordance with another embodiment. In this example, the AI backend (e.g., servers) 204 comprises a service module 206. The service module includes various sub-modules, including for example an orchestrator 208, a machine learning (ML) API 210, an instruction generator 212, a reporting service 214, an integration service 216 and a notification service 218. The backend 204 further includes a number of databases 220 (e.g., Postgres, MongoDB, Neo4J, etc.). The SDK 222 located on the various gaming devices receives algorithm responses 224 from the backend 204 while returning learning call algorithms 226. The dashboard consumers 228 (e.g., managers or others) send via a UI schema, algorithm selections, and requested analytics 230 to the backend 204, and the backend in return sends back the requested responses 232 (analytics, algorithm outputs, etc.).

The schemas 123 are representation of the game universe. They provide a way of representing a player's gameplay interactions with other objects and/or the game environment. An non-limiting example 402 of a UI 125 is illustrated in FIG. 4. Typically, the schema will be described by a user, such as a product manager, which wants to measure and optimize player engagement with the game-related software 112. The schema can be created or edited using a schema editor interface of the UI 125, which will be described further below.

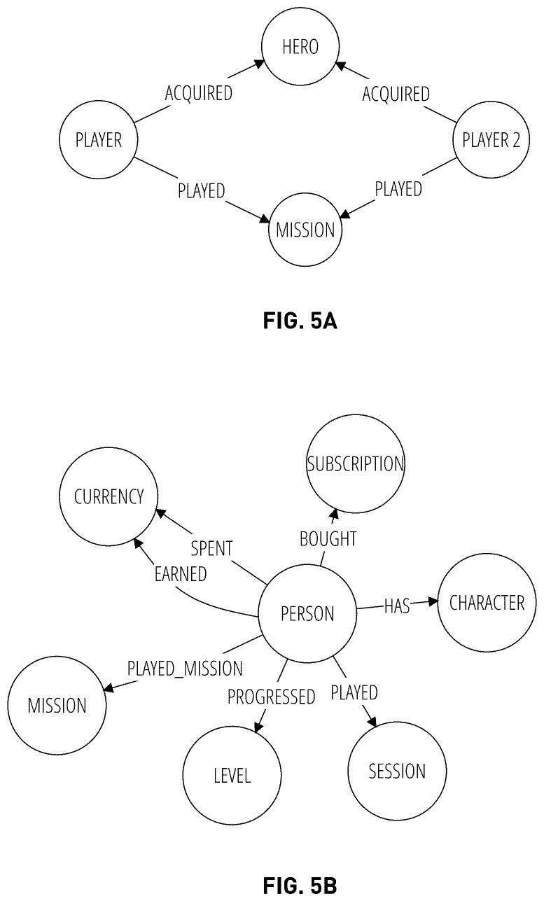

Advantageously, in some embodiments, the server application 115 may be configured to generate via the graph generation module 118 a data layer in the form of a graph representing the described schema. This allows to better and more efficiently represent the game world and the different interactions that may happen between the player with other items/entities/elements thereof. Moreover, core gameplay loops are also easier described through the usage of graphs than with traditional tabular structure data. Embeddings stored in the graph layer are thus more efficiently stored, and retrieved for further processing. Typically, graphs are made up of vertices (e.g., node or points) which are connected by edges (also called links or lines). In some embodiments, nodes are used to represent objects or game-related entities, while edges represent interactions between these objects/entities. FIG. 5A and FIG. 5B each gives an example of a graph describing different entities and the relationship between them. Objects (nodes) represent items or entities that exist in the described universe. Some examples include physical items (e.g., books, cars, phones, etc.) or digital items (e.g., a weapon in a game, a spaceship, etc.). In some embodiments, aside from their name, objects may also contain attributes or labels. Attributes represent the characteristics of the objects. For example, an object named “Weapon” may have attributes related to its type, how rare it is to obtain, since what date that weapon is available in the game, etc. Labels represent an object classification type. In one example, an object “Weapon” may have labels such as “Sword”, “Gun”, “Axe”, etc. Existing labels may be later used by the system to predict labels other objects could or should have. In one example, a game developer may use the system to label users/players as social or not social. Eventually, the graph algorithms may learn to predict social/not social players without the implementer informing the system after enough samples have been collected.

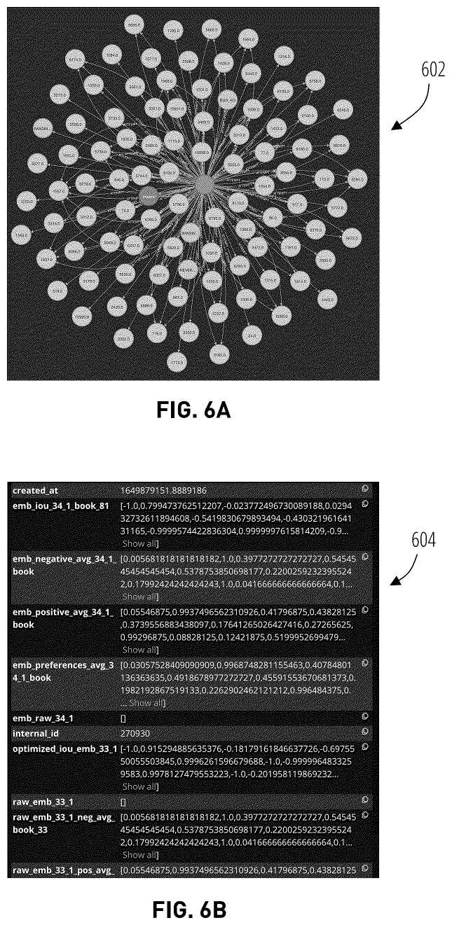

Interactions represent relationships that exist in the described universe. In some embodiments, interactions may represent actions executed by a player on or with certain objects, either representing a physical interaction (e.g., a user bought a new book) or digital (e.g., a player won a level in the game). In some embodiments, interactions may further include interaction attributes. Interaction attributes represent characteristics of an interaction between a player and an object. In one non-limiting example, an interaction of the type “User→Fights→Battle” can have attributes related to how long the battle took to finish, how many enemies were killed and how much health the user lost/gained, etc. The graph provides an efficient means of storing information that is related, and thus allows a more efficient retrieval of that information for processing purposes (e.g., machine learning training and inference). FIG. 6A and FIG. 6B show a larger graph 602 that is more representative of an actual real-world example, and the corresponding list of embeddings 604 stored therein.

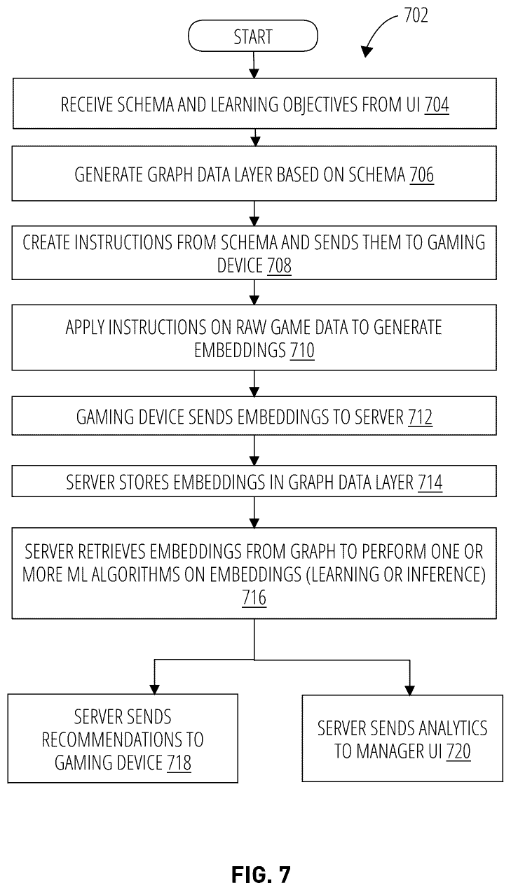

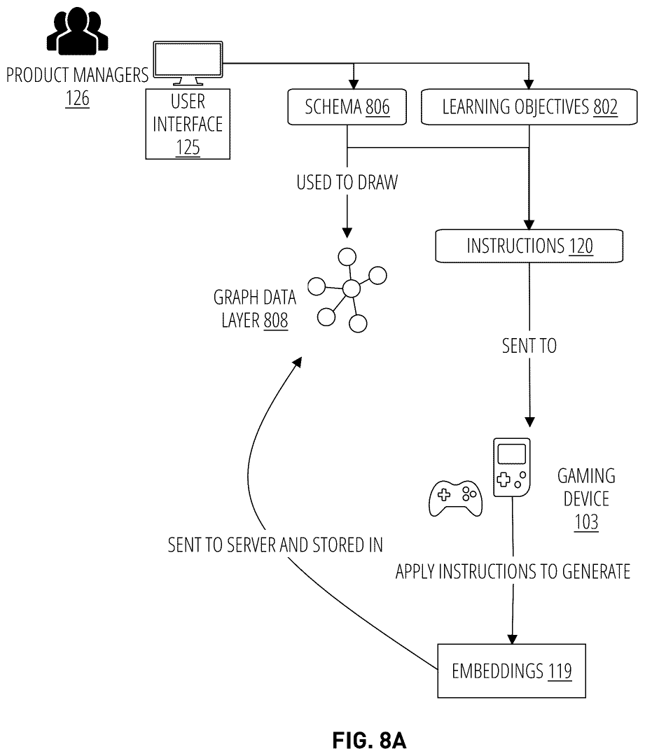

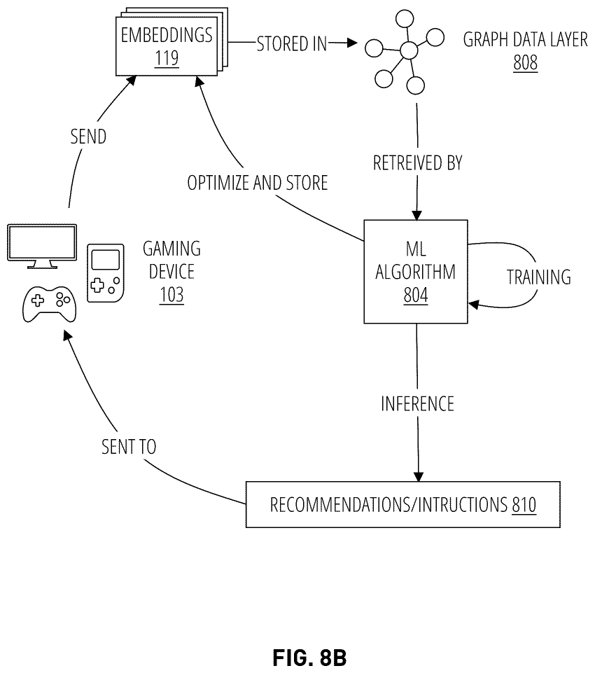

With reference to FIG. 7, FIG. 8A and FIG. 8B, and in accordance with different embodiments, a method for monitoring and optimizing player engagement, referred to by the numeral 702, will be described. At step 704, a game/product manager 126 or the like that wants to improve and track player engagement creates on a user device a schema representing the game word and interactions of interest. In addition, the manager may provide via the UI 125 one or more learning objectives 802 (e.g., things he or she wants to learn about the players and their interactions), or/and request additional tracking information or the like. In some embodiments, the learning objectives 802 may be provided in the form of a selection of machine learning algorithms 804 tailored to infer different outputs from the embeddings generated on local gaming devices. Different machine learning 804 may be selected, without limitation. A list of non-limiting examples of selectable algorithms that may be applied on the embeddings may include:
engagement & Churn Score (e.g., a score to determine players declining in engagement, players fast progressing, and normal players);
recommendations (e.g., to recommend in-game items or content or experience that match the player's preference);
classification & decision attributes (e.g., to predict labels and understand correlations of different game play journeys to the babel);
user sentiment prediction (e.g., to predict how a player will feel about a particular suggested quest or item before presenting it to them);
fake detection (e.g., to detect fake players on a platform); and
predict churn (e.g., to predict whether a particular user is likely to churn within a given number of days).

The various machine learning algorithms may be implemented using different techniques or methods, including deep neural networks, random forest classifiers and the like. In some embodiments, this may include large behavioral models (e.g., models that learn from all interactions a user performs across game devices and game applications and their interactions with other players over time, where these models incorporate an understanding of the players emotion and interest as they interact with different game elements).

Once the manager provides the schema and learning objectives, at step 704 schema 806 and learning objectives 802 are sent to the server application 115. At step 706, the server application 115 generates from the schema 806 the corresponding graph data layer or graph 808, one or more instructions 120. At step 708, the instructions are sent to the gaming device 103 to be processed by the SDK application 114 on the gaming device 103. At step 710, the gaming device 103 apply the instructions 120 on the raw game-related data and generates the embeddings 119. At step 712, the embeddings 119 are sent back to the server and stored at step 714 in the corresponding graph data layer 808 for immediate or later use.

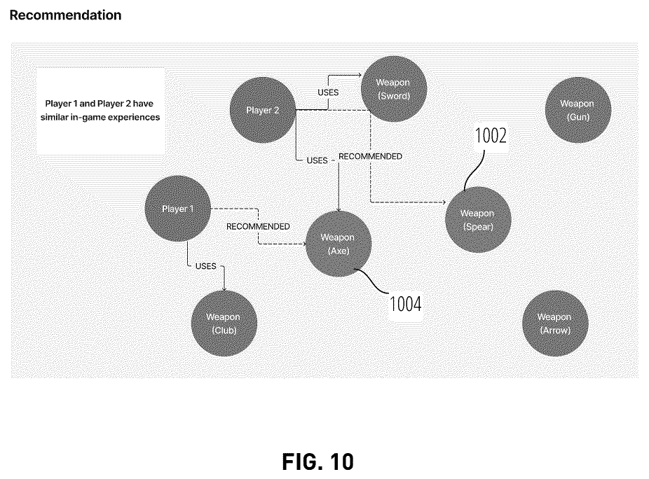

At step 716, one or more designated embeddings are retrieved from the graph data layer to be used by the selected one or more machine learning algorithms. In some embodiments, the embeddings are used for training the models. Different training methods may be used, without limitation. In some embodiments, the ML training can be continuous, or can happen in batches. In some embodiments, to optimize models and make them available for inference, training is performed in the background automatically. In some embodiments, training can be done every time a new batch of embeddings is received. Once trained, the machine learning models may be used to provide inference on the received embeddings to generate predictive outputs. The type of output will depend on the designated algorithms. In one non-limiting example, an output may be in the form of a recommendation of how to adjust one or more of the game's parameters (e.g., difficulty, etc.) to avoid losing player engagement. Once the output 810 has been generated, for example a recommendation, it can be sent to the gaming device 103 at step 718 to be implemented in the game-related software 112 automatically, and/or it can be sent at step 720 to the UI 125 to provide analytics or monitoring information. FIG. 10 provides an example of recommendations (e.g., recommended weapons 1002 and 1004) that can be provided.

In some embodiments, a neural network is configured or designed to optimize the relationship between a user and a target item to allow for predicting future behavior. Success may be dynamically defined through the user dashboard or user interface 125.

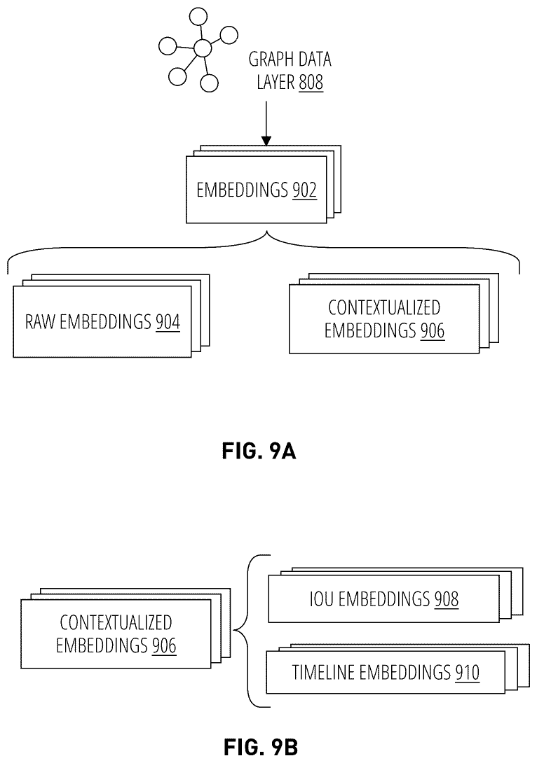

In some embodiments, the system may further process the embeddings received from the gaming devices before being used for training or inference. For example, as illustrated in FIG. 9A and FIG. 9B, the graph data layer 808 may have stored therein a plurality of embeddings 902 comprising both raw embeddings 904 (e.g., embeddings 119 received from the gaming device 103) and contextualized embeddings 906. The contextualized embeddings 906 are raw embeddings 904 that receive further processing/optimizations by the server application 115.

As illustrated in FIG. 9B, the contextualized embeddings 906 may include “IoU” embeddings 908 optimized using Intersection over Union (IoU) methods or the like, and rely on having a user or person object or node in the graph data layer 808. Contextualized embeddings 906 are configured to retain additional contextual information. This allows the server application 115 to model user actions and relationships with objects in the world based on perceived sentiments, for example:
very positive;
positive;
neutral;
negative; and
very negative.

In some embodiments, a given optimized IoU embedding may retain information on:
the item;
the interaction;
the user and similar users; and
similar users' behavior, etc.

In some embodiments, the optimized IoU embeddings may further be designed to evolve in the context of time (e.g., be forgetful). The optimized IoU embeddings provide an improved means of rapidly providing answers to contextual queries by the game manager. In some embodiments, this may be done by using a neural network algorithm to optimize the user embeddings so that the objects or entities they like are closer in parameter space. For example, such a query may include: “Give me the top 3 best matching quests for this person now.”. Using the graph infrastructure, the system may return cosine similarities in milliseconds for the best recommendations. In some embodiments, the contextualized embeddings 906 may include timeline embeddings 910. These are raw embeddings 904 that are processed/optimized to be forgetful and include an indication of how people behavior change with time. This may include how frequently they perform certain actions, how the actions performed frequently change in time, etc. In some embodiments, the system may be further configured to describe how people (e.g., players) change in behavior and emotion as they play a game. This allows the system to deepen the context in time by measuring a change in every session of the game, therefore allowing for understanding of complex emotions and relationships. In some embodiments, change is modeled dynamically based on all the parameters described in schema and play session changes in a designated amount of time (e.g., 24 hours, 3 days, 7 days, 30 days or 112 days). In some embodiments, this allows the server application to perform intervention notification to preemptively keep a player engaged, the other to output predictions to predict when a player may quit or disengage from the game.

In some embodiments, the system of the present disclosure is further configured to predict a degree of interest of a player. This includes using one or more neural networks designed to optimize the relationship between a user and a target item to allow predicting future player behavior. In some embodiments, success may be dynamically defined via the user dashboard or interface 125. Non-limiting examples of predictions include whether a player will succeed in a level, or if the user will buy an offer. In some embodiments, the neural networks are configured to generate an optimal future graph data layer or graph of a user's (player's) behavior. An example is shown in FIG. 10, wherein the system, detecting that player 1 and player 2 have similar in-game experiences, provides the weapon recommendations 1002 and 1004.

In some embodiments, the server application 115 is configured to provide the UI 125 analytical data for the selected algorithms. Analytics may be provided to the game manager (dashboard user) in different ways, including as a function of play sessions, and duration. Other information may include top players, players by level, players at risk, session growth, game quests difficulty gauge, distributions of player success rate or the like. In some embodiments, it is used monitor engagement trends and detect in players changes in patterns and provide interventions.

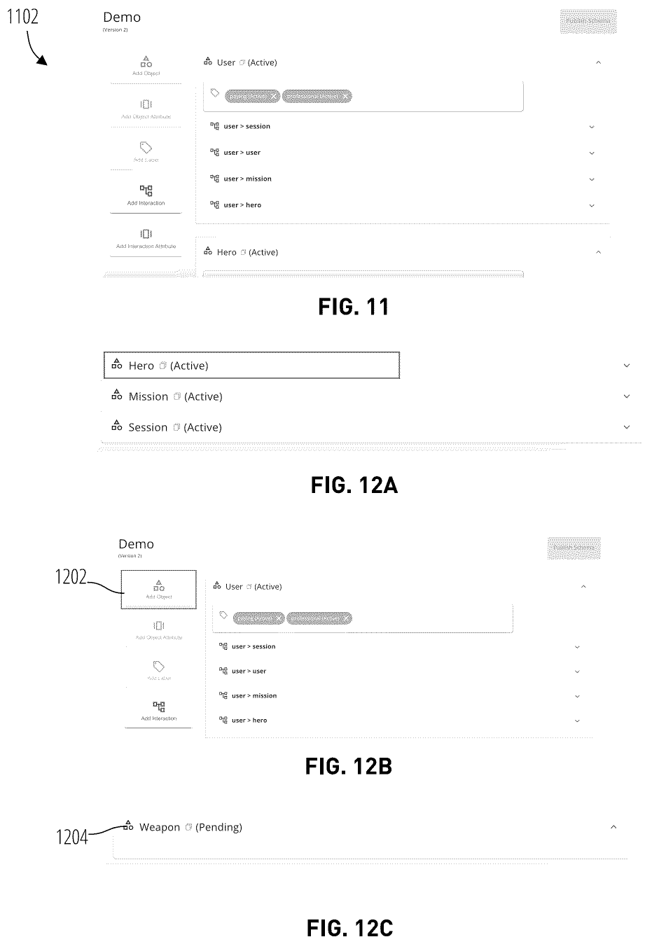

FIG. 11 illustrates an exemplary user interface or dashboard (e.g., UI 125) including a schema builder interface 1102 used by a user, such as a game manager, to define objects, objects attributes, labels, interactions between objects and interaction attributes. As mentioned above, the schemas defined with the interface are used to generate the data layer in the form of a graph on the server which is used to store the various embeddings. These are created by applying instructions on the local gaming device 103, the instructions also generated by the server 102 based on the schema and learning objectives.

As discussed above, objects represent items that exist in the described universe and their attributes. FIG. 12A, FIG. 12B and FIG. 12C show different exemplary interface windows used to add new objects, including adding or removing object attributes. As shown in FIG. 12B, in this example, objects are added by selecting the button 1202 on the left corner named “Add Object”. Once the “Add Object” button is selected, a new form will become visible that allows the user to enter an object name, after which the object will be available in the Schema with the status “pending”. In some embodiments, rules may be automatically applied when creating an object based one or more conventions. For example, in some embodiments the rules may include:
1. the name must be unique within the schema;
2. the names must be provided;
3. names that contain special characters, blank spaces or punctuation will be converted by the UI to use “_” instead of.

FIG. 12C shows an exemplary object named “Weapon” having been created and which is still pending. In some embodiments, objects may also contain attributes and/or labels.

Attributes represent characteristics of the object. For example, an object named “Weapon” may have attributes related to its type, how rare it is to obtain, the date it was made available, etc. Attributes may be added and deleted from the object using the UI. When adding a new attribute, the user may first define which object the attribute will be associated with, then define the attribute name and type. Different types of attributes may be considered, including without limitation:
numbers;
categories;
location (e.g., latitude and longitude, etc.);
dates;
text;
boolean values; and/or
ID values.

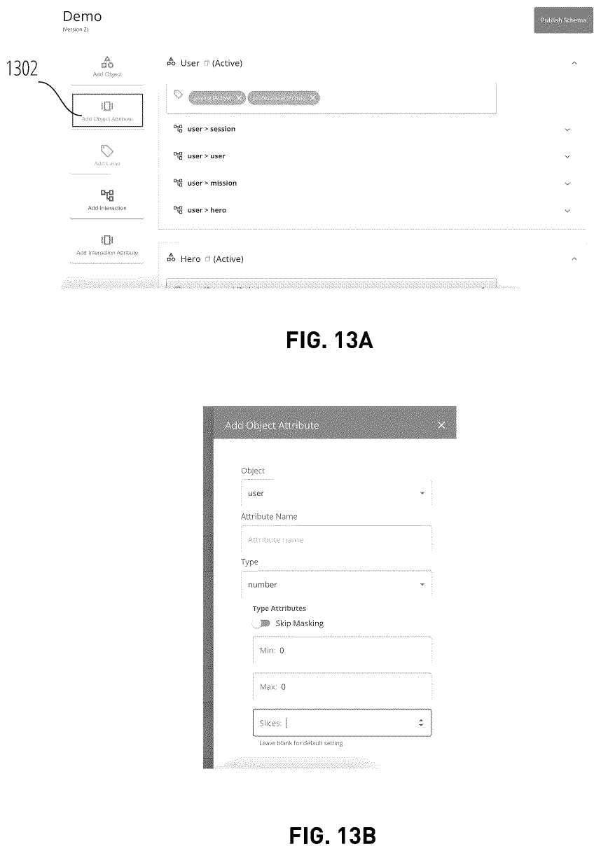

The type of attribute may be used when processing data by the system. Different types of attributes may have the data processed differently or using different machine learning algorithms. To add an attribute in this example, the left handed button “Add Object Attribute” 1302 is provided as illustrated in FIG. 13A. This opens the window shown in FIG. 13B containing a number of selectable options. In some embodiments, the UI may perform verifications before creating the attribute. For example, this may include ensuring that the attributes are:
associated with an object;
a name is provided;
the name is unique for the selected object;
names containing special characters blank spaces or punctuation will be converted by the system to use “_” instead;
a type is provided, and that any mandatory field based on the selected type is also provided.

In some embodiments, the attribute type “number” may contain the following fields:
“Skip Masking”:
   True or False; if True the system will skip the binning process and will use the value as-is.
“Min”:
   number; the minimum value to be used when binning. Must be a positive number and lower than the “Max” field value.
“Max”:
   number; the maximum value to be used when binning. Must be greater than zero and higher than the “Min” field value.
“Slices”:
   number; if blank the system will calculate the binning slices based on the Min/Max value provided, otherwise the number of slices provided will be used. If provided the number must be positive and greater than zero.

In some embodiments, the attribute type “category” may contain the following fields:
“Type Attributes”:
   List of categorical values where at least one is required. Users may add and delete category values. The value provided can contain blank spaces.

In some embodiments, the attribute type “Date” may contain the following fields:
“Min”:
   the minimum date to be used (must be before the current date).

Above, “Skip Masking” includes is a process done to increase privacy to numerical attributes, wherein the system generates dynamically bins based on the learning objective, allowing for increased privacy. In one non-limiting example, the number 3 might be converted to 10 which is an indicator of the bin position.

### Labels

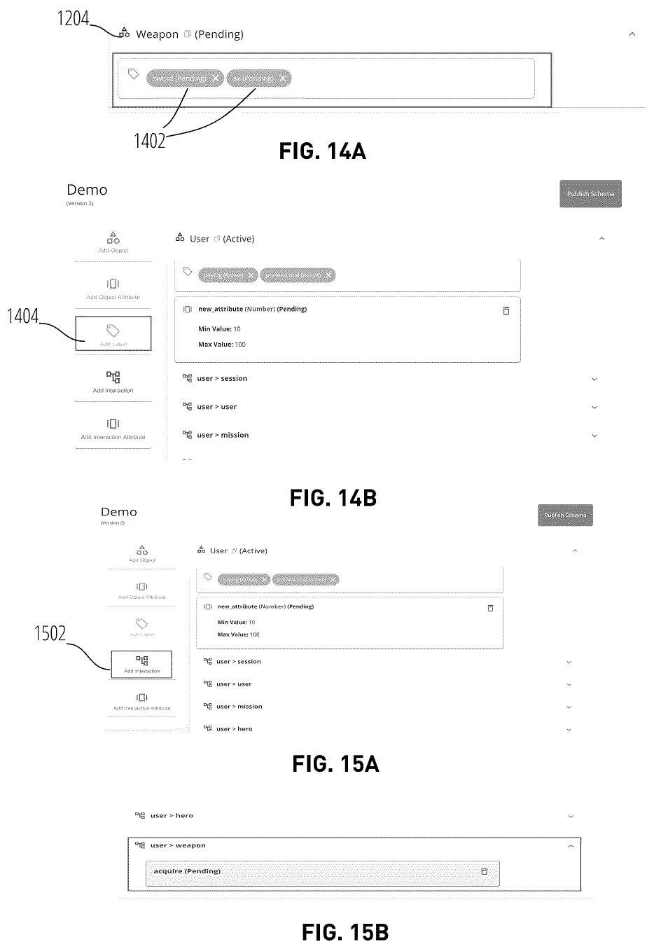

In some embodiments, labels represent object classification types. For example, an object “Weapon” may have labels such as “Sword”, “Gun”, “Ax”, etc. FIG. 14A shows how the UI illustrates the object 1204 having two labels 1402. Labels may be added and deleted from an object. When adding a new label, the user may first define which object the label will be associated with, and then define the label name. As shown in FIG. 14B, labels may be added by selecting the button 1404 on the left corner named “Add Label”. Once created, the new label is made available in the Schema under the selected object with the status of “pending”. Different rules may be applied by the UI when creating a new label. For example, in some embodiments, the rules may include that:
1. the name be unique for the selected object;
2. the name is provided; and
3. names that contain special characters, blank spaces or punctuation will be converted by the UI to use “_” instead.

### Interactions

In some embodiments, interactions represent the relationships that exist in the described universe and may or may not contain attributes. Interactions represent actions executed by a “User” (e.g., player) towards—or with—a designated “object”. The interaction may either represent a physical interaction (e.g., a player bought a new book) or digital (e.g., a player won a level in a game). In some embodiments, interactions may contain attributes themselves. Interactions may be added and have their attributes updated (added or removed), but cannot be removed. In the current example, interactions may be added by selecting the button 1502 on the left corner name “Add Interaction”, as shown in FIG. 15A. Once the button 1502 is selected, a new form appears allowing the user to add an interaction name.

In some embodiments, interactions may only be described from the point of view of the “User” (e.g., object representing the player or person interacting with the game software). For example, a “Monster” (e.g., object) cannot “have” (e.g., interaction) a “Weapon” (e.g., object). Instead, a new “Weapon” attribute may be added to the “Monster” object instead. FIG. 15B shows a new interaction (e.g., “acquire”) having been added between the objects “user” and “weapon”.

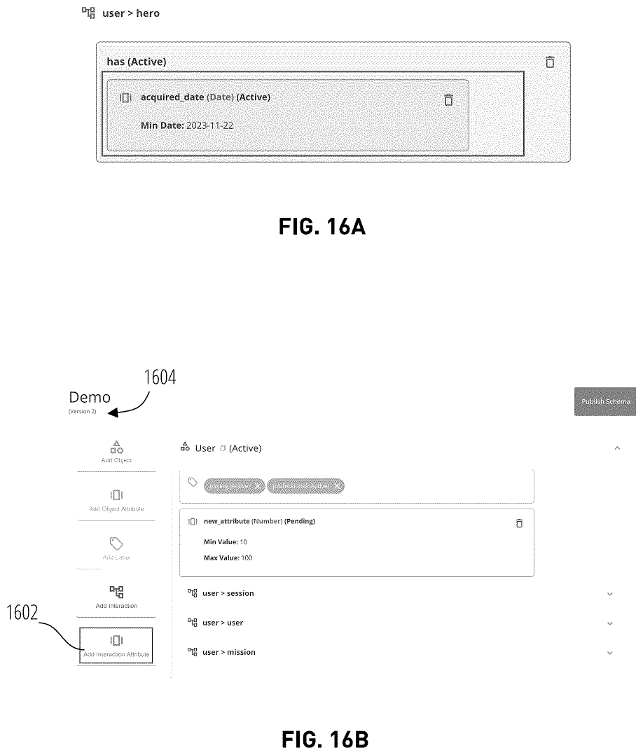

In some embodiments, interactions may also contain attributes. Interaction attributes represent the characteristics of an interaction between a “User” and an “Object”, for example, the following interaction “User→Fights→Battle” can have attributes related to how long the battle took to finish, how many enemies were killed and how much health the user lost/gained, etc. Interaction attributes may be added and deleted from an interaction. When adding a new interaction attribute, the user of the UI may first define which object and interaction name the attribute will be associated with, then define the attribute name and its type. Examples of interaction attribute types may include: number, category, date or Boolean. FIG. 16A shows an example where the “acquire” interaction new has a “date” attribute “acquired_date” with a min value of 2023 Nov. 12. As shown in FIG. 16B, interaction attributes are added by selecting the “Add Interaction Attribute” button 1602 (which may be enabled only once there is at least one interaction available in the Schema). General validation rules, similar to the ones described above, may be applied on interaction attributes as well.

In some embodiments, the system may create a number of default objects and interactions when creating a new schema. Examples of default objects may include a “User” object and a “Session” object. The “User” object cannot be deleted, however attributes, labels and interactions associated with that object may be added or removed. The “Session” object cannot be deleted or modified. The “Session” object is empty by default since it only represents the session date. Moreover, by default, an interaction between the “User” and “Session” objects named “plays” (user→plays→session in the graph) is also created. The interaction “plays” cannot be removed or modified. The interaction also has by default a property named “duration” (e.g., number, skip masking) that cannot be deleted or modified.

In some embodiments, a plurality of versions of the schema generated by a user with the UI may be kept in memory (e.g., versioning). This may include keeping the following three versions of the schema:
published version: used by the system, also known as the released version;
draft version: used in the UI or dashboard to update the Schema as needed; and
archived version: the previously published version.

During the “draft” state, any changes in the schema (e.g., new objects/attributes/labels/interactions or the removal of any) receive the status “Pending” (“Pending delete” in case of deletion). Any changes done in the schema while in the “Draft” state do not impact the system or algorithm training/inference. Once the UI or dashboard user uses the “Publish Schema” button, the system is configured to perform the following actions:
Create a new schema with the “Active” (also known as “Published”);
a new schema with the state “Draft” is created using a clone from the “Active” schema; and
the previously “Active” schema and its objects/interactions/labels/attributes are updated with the state “Archived”.

When creating the new “Active” schema, any objects/interactions/labels/attributes marked with “Pending” have their state to “Ready_to_use”. Any object/interaction/label/attribute marked with “Pending Delete” are not cloned into the “Published” schema. The “Draft” schema version is used as the new Schema version of the “Active” schema. The new “Draft” schema has all the objects/interactions/labels/attributes of the original schema cloned as well. The new “Draft” version uses the previous “Active” schema version plus one. Versions are typically displayed in the upper left corner of the dashboard, for example at location 1604 in FIG. 16B.

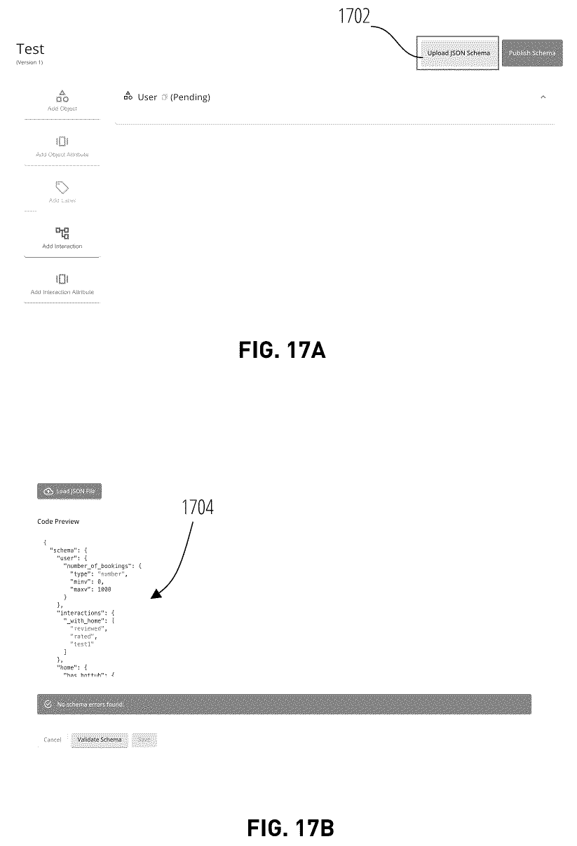

In some embodiments, the UI or dashboard allows the creation of a schema through a JSON file. In the present example, as shown in FIG. 17A, the JSON Schema Uploader can only be used on the Schema first version, by using button 1702. Any updates after the Schema is published must be done through the Dashboard UI. This allows advanced users to define a schema in JSON format. Once the file is uploaded, the system will display a code preview 1704 along with the buttons to validate the schema and save (FIG. 17B). Once the JSON file is successfully validated and saved, the user is redirected to the schema editor discussed above.

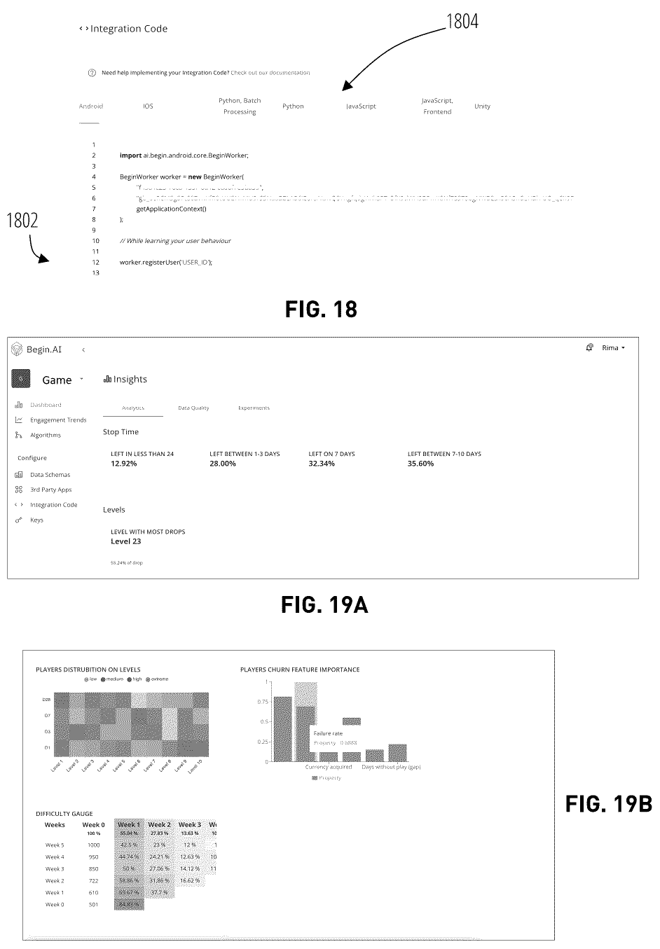

In some embodiments, once the schema is published, users may have access to the integration code and start integrating their platform/game with the SDK application 114, along with visualizing the Dashboard information and enabling one or more machine learning algorithms for training/inference. FIG. 18 shows an example of integration code 1802 generated (in this case for integration in an Android application). Code can be generated for a plurality of different platforms 1804 as also shown. The code generated is based, at least in part, on the objects, attributes, labels and interactions defined in the schema. New versions of the schema may trigger different lines available in the integration code. The integration code allows to make recommendations on what parameters to adjust and by how much. Additional code in the game-related software 112 included by the game developer defines how the recommendations are implemented in practice.

In some embodiments, once the schema is published, the server (e.g., server 102 or the like) generates the instructions used by the SDK application 114 on the gaming device 103 to extract signals from the raw data 122. The instructions contain the order in which the raw data 122 must be processed and send to the server 102. Different types/objects/labels/identifiers will be handled differently by the SDK application 114.

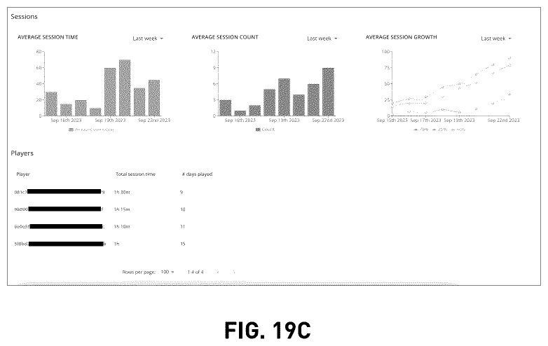

In some embodiments, the dashboard analytics, data quality and experiments use the objects/attributes/labels/interactions defined on the published schema in order to provide users such as game managers with more detailed information about their platform/game. Analytics may be presented via the UI or dashboard using different tables and/or graphical representations as shown in the examples of FIG. 19A-19C.

In some embodiments, various machine learning algorithms (e.g., ML algorithms 117) are offered to the user. Designated machine learning algorithms may be enabled based on the parameters configured through the Dashboard/UI (e.g., UI 125). In some embodiments, the available properties to be used on a given algorithm are retrieved from the latest published schema. The server (e.g., server 102) trains the different models based on the attributes selected.

In some embodiments, machine learning algorithms may require a number of specific attributes. In the example given above, these are:
Engagement & Churn Score: target object to be used, time field, list of metrics to be applied (where each metric must have a metric name and aggregation function-sum, max, min, count) and a user group/ID field;
Recommendation: objects to be used, list of interactions (where each interaction must have a name and a weight—e.g., dead, super negative, negative, positive, super positive);
Text-based recommendation: objects to be used, list of interactions (where each interaction must have a name and a weight—e.g., dead, super negative, negative, positive, super positive);
Category Prediction & Decision: objects to be used, list of labels to be applied (checkbox list);
User Sentiment Prediction: objects to be used, list of interactions (where each interaction must have a name and a weight—e.g., dead, super negative, negative, positive, super positive);
Fake Detection: objects to be used, list of labels to be applied (checkbox list);
Predict Churn: session (object & property), progress (object & property), earn (object & property), spend (object & property) and In-App Purchase (object & property).

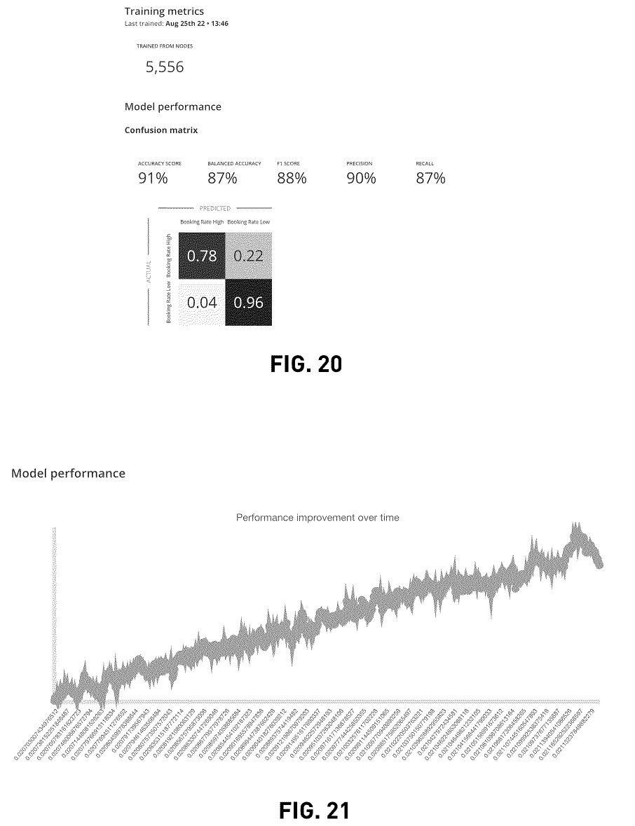

Once an algorithm is enabled, the system will train the model with the provided attributes/characteristics. In some embodiments, training may be triggered any time a certain amount of new data is provided. Different algorithms have different rules for when to trigger. Once the training is done, UI/Dashboard users can use the desired SDK application 114 to perform inference, and visualize the model details. FIG. 20 illustrates an exemplary training metric window presenting a model's performance including a confusion matrix. FIG. 21 shows an exemplary plot generated by the dashboard that allows to visualize performance improvements over time.

Once the initial schema is published and the SDK application is integrated into the customer platform (e.g., gaming device 103), the system may then start the process of analyzing individual player behaviors and suggesting intervention dates. Dashboard users may visualize a specific player behavior through various measured engagement trends available in the dashboard. Engagement trends typically measure the rate of change of one or more parameters in the game that tracks progress of the player (e.g., currency earned, success rate in a quest, session duration, etc.), and measure the change over time and accordingly predict decline or increase in engagement.

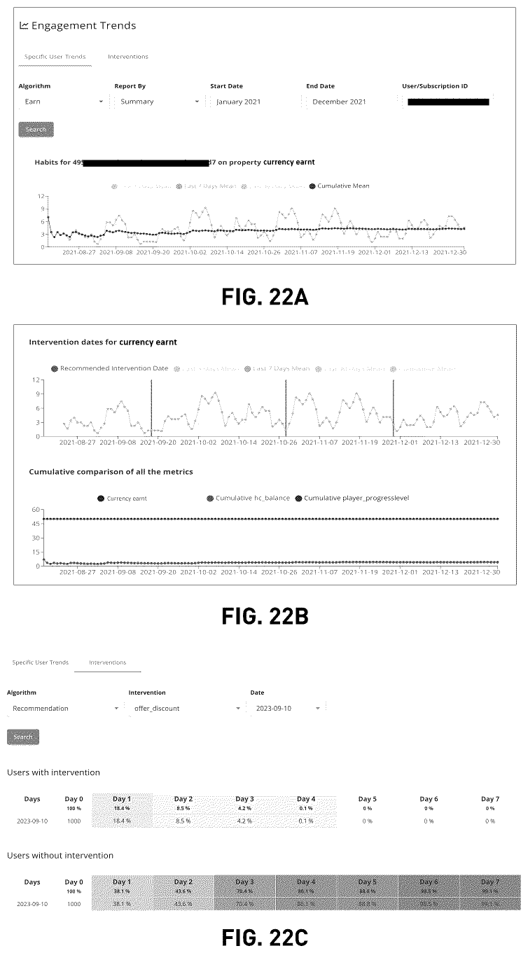

FIG. 22A and FIG. 22B show examples of dashboard windows displaying plots of the change in engagement over time. FIG. 22B shows the trends superimposed on the intervention dates. Once a player has an intervention date, the system may recommend which actions should be applied to increase the change of this player not churning. Interventions are tracked through the SDK application 114 and visualized in the UI/Dashboard 125 through an intervention tabs, as shown in FIG. 22C.

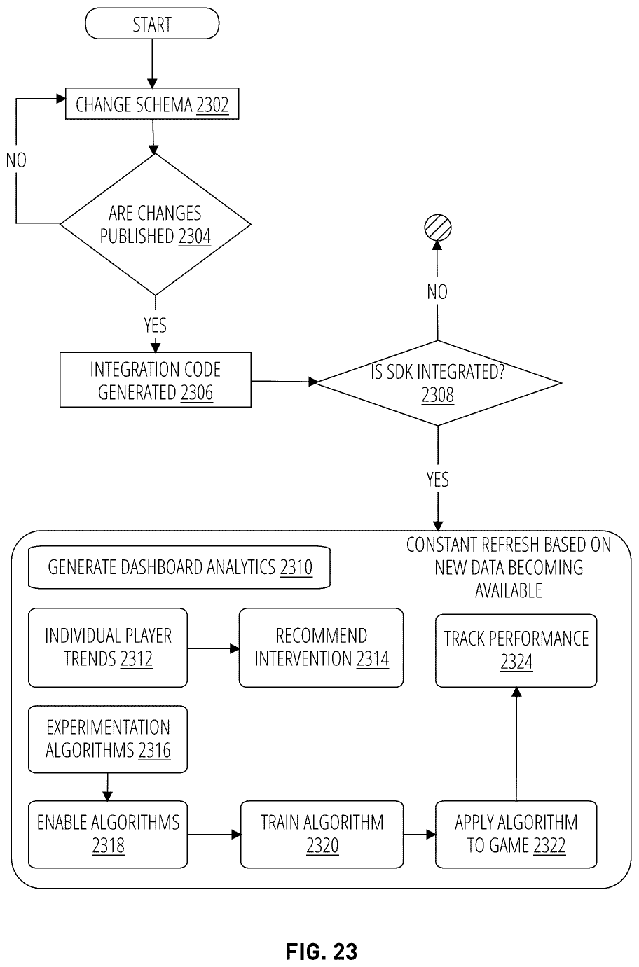

Some of the steps above are summarized in the flow diagram of FIG. 23, where at step 2302 a schema is created or changed/edited. Once the changes are published (step 2304), the corresponding integration code is generated at step 2306. If the SDK integrated and the integration code included in the game-related software (step 2308), then the system (e.g., system 101, 202 or other embodiments thereof) provides automatically a range of services, including:
generating dashboard analytics (step 2310);
providing individual player trends (step 2312), and recommended interventions (step 2314) to keep players engaged;
experimentation algorithms (step 2316);
enabling machine learning algorithms (step 2318), which includes training (step 2320) and applying the algorithms (e.g., inference) to the embeddings (step 2322); and
tracking performance (e.g., intervention performance and/or prediction accuracy) (step 2324).

These processes happen in parallel initially, and may then be constantly refreshed based on new data becoming available.

Many of the functional units described in this specification have been labeled as “engines”, or “modules”, and/or “buttons” in order to more particularly emphasize their implementation independence. For example, an engine or module may be implemented as a hardware circuit comprising custom VLSI circuits or gate arrays, off-the-shelf semiconductors such as logic chips, transistors, or other discrete components. An engine may also be implemented in programmable hardware devices such as field programmable gate arrays, programmable array logic, programmable logic devices or the like.

Engines and modules may also be implemented in software for execution by various types of processors. An identified engine of executable code may, for instance, comprise one or more physical or logical blocks of computer instructions which may, for instance, be organized as an object, procedure, or function. Nevertheless, the executables of an identified engine need not be physically located together, but may comprise disparate instructions stored in different locations which, when joined logically together, comprise the engine or module and achieve the stated purpose for the module.

Indeed, an engine or module of executable code may be a single instruction, or many instructions, and may even be distributed over several different code segments, among different programs, and across several memory devices. Similarly, operational data may be identified and illustrated herein within engines, and may be embodied in any suitable form and organized within any suitable type of data structure. The operational data may be collected as a single data set, or may be distributed over different locations including over different storage devices, and may exist, at least partially, merely as electronic signals on a system or network. Where an engine or portions of an engine are implemented in software, the software portions are stored on one or more computer readable storage media.

The term “memory”, “machine-readable storage medium” or “computer readable medium” as used herein refers to any medium or media that participates in providing instructions to a processor for execution. Such a medium may take many forms, including, but not limited to, non-volatile media, volatile media, and transmission media. Non-volatile media include, for example, optical or magnetic disks, such as data storage devices. Volatile media include dynamic memory, such as random access memory (RAM). Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

The term “processor” includes general-purpose microprocessors, microcontrollers, a Digital Signal Processors (DSP), Application Specific Integrated Circuits (ASIC), Field Programmable Gate Arrays (FPGA), Programmable Logic Devices (PLD), discrete hardware components, or any other suitable entity that can perform calculations or other manipulations of information. One or more processors in a multi-processing arrangement may also be employed to execute the sequences of instructions contained in a memory. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Information as herein shown and described in detail is fully capable of attaining the above-described object of the present disclosure, the presently preferred embodiment of the present disclosure, and is, thus, representative of the subject matter which is broadly contemplated by the present disclosure.

What is claimed is:

1. A computer-implemented method, comprising the steps of:
generating, on a server, a storage layer in the form a graph drawn according to a schema description of objects and relationships in a virtual game environment;
producing, at the server, from the received schema and one or more one or more learning system objectives, one or more instructions;
transmitting, via a network, from the server to a gaming device configured to execute an interactive software, the one or more instructions;
applying, by the gaming device, the one or more instructions on raw data generated by the interactive software to create the one or more embeddings;
returning, from the gaming device to the server, the one or more embeddings;
storing, at the server, the one or more embeddings in the graph;
retrieving, at the server, by a machine learning algorithm, one or more designated embeddings from the graph;
performing, at the server, one or more data inference tasks on the designated embeddings by one or more machine learning algorithms to produce one or more predictive outputs; and
adjusting, at the gaming device, one or more parameters of the interactive software in accordance with the one or more predictive outputs.

2. The computer-implemented method of claim 1, further comprising the steps of, before said generating:
receiving, at a user device, from a user, via a user interface of said second device, the schema description and the one or more learning objectives; and
transmitting, from the second user device to the server, the schema and the one or more learning objectives.

3. The computer-implemented method of claim 1, wherein nodes of the graph represent game-related real-word or virtual entities, and the edges represent relationships between the entities.

4. The computer-implemented method of claim 3, wherein the game-related real-world or virtual entities include a person using the interactive software.

5. The computer-implemented method of claim 1, further comprising the step of, before said performing:
training the one or more machine learning algorithms on the one or more embeddings.

6. The computer-implemented method of claim 1, wherein said designated embeddings include contextualized embeddings.

7. The computer-implemented method of claim 6, wherein the contextualized embeddings are generated by:
fetching, by the server, raw embeddings received from the gaming device from the graph;
optimizing, by the server, the raw embeddings into contextualized embeddings; and
returning, by the server, the contextualized embeddings to the graph for storage.

8. The computer-implemented method of claim 6, wherein the contextualized embeddings include contextual information selected from the list of: an item; an interaction; a user and similar users; and similar user behavior.

9. The computer-implemented method of claim 6, wherein the contextualized embeddings include timeline embeddings, the timeline embeddings comprising time-related parameter change information.

10. A system comprising:
a server, the server configured to:
generate a storage layer in the form a graph drawn according to a schema description of objects and relationships in a virtual game environment; and
produce from the schema description and one or more learning system objectives, one or more instructions;
a gaming device configured to execute a designated interactive software and communicatively coupled to the server via a network, the gaming device configured to:
receive the one or more instructions from the server;
apply the one or more instructions on raw data generated by the interactive software to create the one or more embeddings;
return to the server the one or more embeddings; and
wherein the server is further configured to:
store the one or more embeddings in the graph;
retrieve via a machine learning algorithm, one or more designated embeddings from the graph;
perform one or more data inference tasks on the designated embeddings via the machine learning algorithm to produce one or more predictive outputs; and
wherein the gaming device is further configured to adjust one or more parameters of the interactive software in accordance with the one or more predictive outputs.

11. The system of claim 10, further comprising a user device communicatively coupled to the server, and operate to generate a user interface via a display of the user device;
wherein the user device is further configured to receive, via the user interface, the schema description and one or more learning objectives;
transmit the schema and the one or more learning objectives to the server.

12. The system of claim 10, wherein nodes of the graph represent game-related real-word or virtual entities, and the edges represent relationships between the entities.

13. The system of claim 12, wherein the game-related real-word or virtual entities include a person using the interactive software.

14. The system of claim 10, wherein the server is further configured to, before performing the one or more data analysis tasks, to train the one or more machine learning algorithms on the one or more embeddings.

15. The system of claim 10, wherein said designated embeddings include contextualized embeddings.

16. The system of claim 15, wherein the server generates the contextualized embeddings by:
fetching raw embeddings received from the gaming device from the graph;
optimizing the raw embeddings into contextualized embeddings; and
returning the contextualized embeddings to the graph for storage.

17. The system of claim 15, wherein the contextualized embeddings include contextual information selected from the list of: an item; an interaction; a user and similar users; and similar user behavior.

18. The system of claim 15, wherein the contextualized embeddings include timeline embeddings, the timeline embeddings comprising time-related parameter change information.
